(19) United States
(12) Patent Application Publication
(10) Pub. No.: US 2013/0302654 A1
(43) Pub. Date: Nov. 14, 2013

(54) ELECTRICAL COMPONENT HAVING A DEVICE FOR ISOLATING AN ELECTRICAL LINE CONNECTION

(71) Applicant: Tim Schaefer, Harztor (DE)

(72) Inventor: Tim Schaefer, Harztor (DE)

(73) Assignee: Li-Tec Battery GmbH, Kamenz (DE)

(21) Appl. No.: 13/885,773

(22) PCT Filed: Nov. 8, 2011
(86) PCT No.: PCT/EP2011/005609

§ 371 Date: Jul. 30, 2013

(30) Foreign Application Priority Data
Nov. 17, 2010 (DE) 10 2010 051 669.4

(51) Int. Cl. H01M 2/34

(52) U.S. Cl. CPC H01M 2/34
USPC 429/50; 429/61

(57) ABSTRACT

The invention relates to an electrical component having a device for isolating an electrical line connection, wherein said electrical component comprises a reactive multi-layer structure in order to effect isolation of the electrical line connection. The electrical component can be a galvanic cell, and the device for isolating can be disposed outside or inside the cell. The electrical component can also be a cell connector. A quick and reliable isolation of galvanic cells from a combination of several galvanic cells or a quick and reliable dismantling of large cells into segments can be achieved.

The present invention relates to an electrical component, particularly a galvanic cell or a cell connector for galvanic cells, having a device for isolating an electrical line connection.

Galvanic cells such as for instance batteries (primary storage) and accumulators (secondary storage) for storing electrical energy composed of one or more storage cells are known in which when a charging current is applied, electrical energy is converted into chemical energy in an electrochemical charge reaction between a cathode and an anode in or between an electrolyte and thus stored, and in which when an electrical load is connected, chemical energy is converted into electrical energy in an electrochemical discharge reaction. In recent years, primary and secondary storage systems based on lithium compounds have been steadily gaining in importance. For example, lithium ion accumulators are recommended and used for a plurality of applications today, including as traction batteries for motor vehicles. To this end, individual cells are assembled and interconnected in blocks in order to provide the respectively required voltages and capacities. Battery systems often require high voltages of hundreds of volts. Under certain circumstances, for instance an accident, a critical charge state or a critical operational state, it can be desirable to isolate individual cells or groups of cells of the battery system.

It is thus an object of the present invention to provide an electrical component having a device for isolating an electrical line connection, whereby among that which is made possible is reliably interrupting the current flow to and/or from a galvanic cell.

This object is accomplished by the features of the independent claims. Advantageous further developments of the invention constitute the subject matter of the subclaims.

From one standpoint, the present invention relates to an electrical component having a device for isolating an electrical line connection characterized in that the device comprises a composite of at least two different materials.

The term “composite” encompasses two or more bonded materials. The term “material” encompasses elements of the periodic table as well as compounds derived therefrom such as inorganic or organic compounds.

The at least two different materials are preferably selected such that they can be made to react with one another, thereby inducing the isolating of the electrical line connection.

In one embodiment, the composite is disposed on a section of the line connection and the materials selected such that thermal energy is released upon their reaction which causes the line connection to fuse over some or all of its cross section.

In one embodiment, the thermal energy released in the reaction causes a fusing of the line connection over a portion of its cross section, whereby the remaining cross section of the line connection fuses upon a normal operating current flowing through the conductor section.

Composites of at least two different materials which can be made to react with one another to release thermal energy; i.e. made to react in an exothermic reaction, are well known.

Employing a so-called “nanometer reactive multilayer structure” as a composite is known from the “Fraunhofer IWS Jahresbericht 2008” (2008 annual report from the Fraunhofer IWS R&D institute), p. 76, here as an energy storage used to join heat-sensitive components. Such “nanometer reactive multilayer structures” (“RMS”) can consist of several hundred up to a few thousand individual layers measuring 10-100 nm in thickness, each consisting of at least two different materials, the chemical compound of which releases energy (exothermic reaction). Thus, an RMS stores a defined amount of chemical energy which can be used as a local heat source. After being ignited by an external energy source such as an electric spark or a laser pulse, for example, an atomic interdiffusion of the multilayer materials is induced, releasing energy. A progressive reaction front develops which release a high amount of heat within a tightly restricted space in a very short amount of time. For example, fast-reacting multilayer foils are used as local heat sources to produce soldered connections in so-called exothermic soldering foil; heat and voltage input into adjacent components can thereby be minimized. RMS is produced to have total thicknesses up to 100 μm, for example via a physical gas phase separation process such as magnetron/ion-beam sputter deposition, and can be coated directly on the respective components or produced as a separate foil. With material combinations such as for instance Ni/Al or Ti/Al, local temperatures of up to 2000° C. as well as propagation speeds of 2-20 m/s have been achieved. In one embodiment, a “reactive multilayer” or “reactive multilayer structure” in terms of the invention is to be understood as any composite which comprises at least two different materials in layered form which can be made to react with one another. This means that a “reactive multilayer” or “reactive multilayer structure” is composed of reactive multilayers or one reactive multilayer. In terms of the invention, one “reactive multilayer” is to be understood as a layer of a plurality of individual layers having thickness preferably within the nanometer range, wherein the multilayer materials react with one another upon a well-defined condition occurring such as e.g. a specific temperature or upon a signal being supplied such as for instance a voltage pulse, an electric spark or a laser pulse, preferably by inducing an atomic interdiffusion of the multilayer materials accompanied by the release of energy. Initiating of the reaction is also called “igniting” the multilayer. The reaction is preferably sustained without further assistance until the multilayer materials are consumed. The structure can in particular have a coating, a separate foil structure, which can be self-adhesive if need be, or the like.

In accordance with one preferred embodiment, a composite of at least two different materials, e.g. a reactive multilayer structure, is disposed on a conductor section, wherein thermal energy released upon a reaction of the reactive multilayer causes a fusing of some or all of the conductor section cross section. The reactive multilayer structure can hereby be, for example, an exothermic soldering foil as known from the prior art, wherein after being ignited, a progressive reaction front develops which releases a high amount of heat within a tightly restricted space in a very short amount of time. Hence, an isolating in the form of a safety fuse is implemented, wherein a conductor section melts away and the gap in the line connection causes an isolating of the line. The reaction can also ensue very quickly and be locally limited without the adjacent component structures being affected. When the trigger for igniting the reactive multilayer structure is a temperature rise condition, the exothermic reaction intensifies said temperature rise condition and leads to a reliable and accelerated fusing of the respective conductor section. The reaction is also self-perpetuating and therefore also enables reliable electrical isolation.

If the thermal energy released in the reaction of the reactive multilayer is limited to the extent that it only fuses part of the conductor section cross section, whereby the remaining cross section of the conductor section fuses upon a normal operating current flowing through the conductor section, the thermal energy generated, and thus a thermal detriment to adjacent elements, can be kept to a minimum. For the purposes of the invention, a normal operating current refers to a current at an amperage which would prevail in the line connection under the normal operating conditions of the electrical component.

Noted as being preferentially utilizable for the at least two different materials in the composite are combinations of elementary metals which react to form alloys or metallic glass; elements or compounds which form silicides with silicon or silicon compounds, particularly binary metallic compounds of silicon; elements or compounds which form aluminides with aluminum or aluminum compounds, particularly binary compounds of aluminum, preferably magnesium aluminide, nickel aluminide, titanium aluminide; elements or compounds which form boride with boron or boron compounds, preferably magnesium boride; elements or compounds which form carbide with carbon or carbon compounds; thermites, preferably thermites based on ferric oxide as one material of the at least two different materials and aluminum as the other material of the at least two different materials.

In accordance with an alternative embodiment, the composite, for example in the form of a reactive multilayer structure, is disposed between two conductor sections and electrically conductive in an unreactive state, wherein the reaction product of the reactive multilayer structure is not electrically conductive. Thus, a line isolating can also be realized as a type of solid isolator. The ends of the line connection thereby remain spatially fixed.

In this embodiment, the composite is affixed to a section of the line connection and is itself electrically conductive, whereby the at least two different materials are selected such that an electrical isolator will form upon their reaction as a reaction product.

It is conceivable in one embodiment to select an electrically conductive material such as graphite or graphene as one material of the at least two different materials. It is further conceivable to select an electrically non-conductive oxygen donor as the further of the at least two different materials so that electrically non-conductive oxides of the graphite or graphene will form upon the graphite or graphene reacting with the oxygen donor.

In one embodiment, the component is also characterized in that the at least two materials of the composite are in the form of alternating layers.

The layers preferably independently exhibit a diameter of from 1 to 100 nm.

Preferentially, there are between 50 and 10,000 layers in the composite.

Known methods can be used to produce the composite, also in the form of a reactive multilayer structure, for example as known from the above-indicated “Fraunhofer IWS Jahresbericht 2008.” Alternating layers of the at least two different materials are preferably deposited on a substrate by methods such as rolling onto same, chemical or physical gas phase separation, vacuum deposition and/or sputter coating.

In accordance with preferred embodiments, the at least two different materials in the composite, for example in the reactive multilayer structure, are designed to react, preferably to ignite, upon a predefined reaction condition, preferably an ignition condition, being met, wherein the reaction condition or ignition condition is preferably given by at least one of the conditions:
exceeding of a predefined threshold for a current flowing through the conductor section;
exceeding of a predefined threshold for applied voltage over the conductor section;
exceeding of a predefined threshold for a temperature prevailing in the reactive multilayer structure or the conductor section;
exceeding of a predefined threshold for an electric potential applied to the reactive multilayer structure;
the force effect as a result of an impact or collision.

The reaction or the ignition is preferably triggered by the input of a current, voltage, temperature, light, acoustic, UV or laser signal or pulse or other suitable signal.

Depending on requirement, the reaction of the at least two different materials in the composite, for example the igniting of the reactive multilayer structure, can thus ensue either automatically by suitably defining the design parameters or actuated by specific control. In the case of a galvanic cell, for example, the reactive multilayer structure can be designed such that both an overheating of the cell as well as a selective ignition pulse of a battery management or cell logics system triggers a reaction of the reactive multilayer structure.

In accordance with a preferential embodiment, the component is a cell connector for the electrical connection between galvanic cells comprising a device for contacting pole connections of galvanic cells. In terms of the invention, a galvanic cell can also refer to any apparatus which is designed and disposed to discharge electrical energy. This can be particularly, but is not limited to, an electrochemical memory cell of primary or secondary type (battery or accumulator cell), a fuel cell or a capacitor cell. In terms of the invention, a pole connection is to be understood as a region which also enables electrical energy from outside the cell to be exchanged with the active part. Such pole connections can be particularly, but are not limited to, plate-shaped, pin-shaped, terminal-like or pressure key-like conductive areas connected to the interior of the galvanic cell. Plate-shaped pole connections guided through a cell enclosure are in particular also referred to as current conductors. In terms of the invention, a cell connector refers to a component connecting a pole connection of a galvanic cell to a pole connection of another cell. To be understood as a contacting device in terms of the invention is any structural element which enables a reliable electrical connection to be made with a pole connection. Depending on the design of the pole connection, such devices can for example be, but are not limited to, sections in the form of plugs, clips, sleeves, cable shoes or the like or exhibiting structural features which, together with screws, rivets or other fixing elements, enable a fixing to the pole connection. A cell connector comprising a reactive multilayer structure as a device for isolating an electrical line connection can realize an effective external protective circuit able to reliably isolate a cell or a group of cells from another cell or another group of cells. No change in the cell design is necessary.

In accordance with a further preferred embodiment, the component is a galvanic cell, wherein the isolating device is allocated to a section or a plurality of sections for conducting electrical current to and/or from an active part of the galvanic cell. To hereby be understood as an active part is that part of the cell within which electrochemical charge, discharge and electrical energy conversion processes also occur when needed. The active part preferably comprises foil layers of electrochemically active materials (electrodes), conductive materials (current collectors or simply collectors) and separating materials (separators). In terms of the invention, a foil refers to a thin semi-finished product produced from a metal and/or a plastic (e.g. polyimide or the like). The foil can thereby serve as a substrate for a material having the desired electrical and/or chemical properties or can itself be produced from a material with the cited properties. Electrochemically active material is to be understood in the broadest sense as a material which also takes an active part in an electrochemical reaction within the active part. Collector material is to be understood in the broadest sense as a material which is also suited to collecting and conducting electrical charges and is connected to the respective electrode areas. A collector foil can for example be, but is not limited to, a conductor foil, particularly a metal foil, or a plastic foil coated with a conductive material, particularly metal. Separator material is to be understood in the broadest sense as a material which can be disposed between an anode region (negatively charged area) and a cathode region (positively charged area) of a galvanic cell in order to separate said regions. While largely impermeable (electrically insulating) to charge carriers (electrons), separator material is at least partially permeable to ions. The separator material preferably contains an organic base material, particularly polymeric, which is at least partially permeable to material such as PET, for instance, preferably in the form of a non-woven fibrous material, and an inorganic material, particularly ceramic, such as zirconium oxide, for instance, preferably in the form of particles, the largest diameter of which is preferably no larger than 100 nm. Such a material combination corresponds to that of a foil material as marketed under the trade name of Separion. In preferred modifications, the inorganic material can also be another suitable ceramic composite, particularly from among the group of oxides, phosphates, sulfates, titanates, silicates, aluminosilicates of at least one of the elements of Zr, Al, Li. Generally speaking, the separator material can be any lithium ion-conducting electrolyte. By the isolating device being a section or a plurality of sections associated with conducting electric current to and/or from an active part of the galvanic cell, an effective external protective circuit can be realized which reliably isolates a cell or a group of cells from another cell or another group of cells. The protective circuit can be inseparably connected to the cell as part of the cell design and thus increases the degree of integration.

The isolating device preferably exhibits a reactive multilayer structure allotted to a connecting section between a collector section of an active part of the cell and a pole section of the cell or between contacting sections for contacting a collector section of an active part of the cell on the one hand and a pole section of the cell within a cell enclosure on the other. In terms of the invention, a collector section refers to a section of a collector region which preferably leads out of the active part for contacting purposes. The collector region can be a collector foil as described above. An enclosure (cell enclosure) in the sense of the invention also refers to a gas-tight, vapor-tight and liquid-tight casing which accommodates at least the active part, enclosing it on all sides. An enclosure can in particular be, but is not limited to, a foil structure (coffee bag or pouch cell, etc.) or a frame structure (flat-cell frame or the like) or a box structure (flat contact cell or the like). In terms of the invention, a pole section is to be understood as a portion of a conductor section disposed within the cell which also allows an exchange of electrical energy from external the cell with the active part. In particular, a pole section can be a section of a current conductor within the cell guided through the cell enclosure or a part of a cell enclosure, particularly an inner side of a (pole section-forming) cell enclosure.

An alternative or additional option which is just as preferential is for the isolating device to comprise a reactive multilayer structure which is disposed on at least one current conductor internal or external of a cell enclosure.

As a likewise preferential alternative or additional option, the isolating device alternatively comprises a reactive multilayer structure which is disposed on at least one conductor tab of a collector foil internal or external of a cell enclosure.

A device, particularly an electric line, is preferably provided to introduce an external ignition pulse to the isolating device or to the reactive multilayer structure respectively. The electric line can also be a part of a conductor section on which the reactive multilayer structure is disposed. Such a device for introducing an external ignition pulse enables the reactive multilayer structure to be selectively ignited from the outside.

Alternatively, or as an additional option, a device is preferably provided, particularly a switching device preferably controllable from the outside, for short-circuiting the cell or a part of the cell and for conducting a short-circuit current to the isolating device. A short-circuit current is in principle higher than a normal operating current for which the galvanic cell is designed. A short circuit also often causes the destruction of a galvanic cell. When, however, the short-circuit current is directed to the isolating device, this current is able to ignite the reactive multilayer structure, whereupon both the shorted circuit as well as the current flow to and from the cell are interrupted.

An ignition of the reactive multilayer structure can preferably be triggered by a cell management system or a battery management system which manages a plurality of galvanic cells. It is further preferable to provide for a device to detect cell status parameters and signal a status parameter to the cell management system and/or the battery management system. It is thus also possible to monitor cell status parameters and other structural elements of the cell's operating environment and to selectively isolate the cell or a group of cells or a section of a cell as necessary by igniting the reactive multilayer structure.

The above and further features, objects and advantages of the present invention will become more apparent from the following description which makes reference to the accompanying drawings. Shown are:

FIG. 1 a plan view of a galvanic cell having conductor tabs in accordance with an embodiment of the present invention, whereby an enclosure is omitted to simplify the depiction;

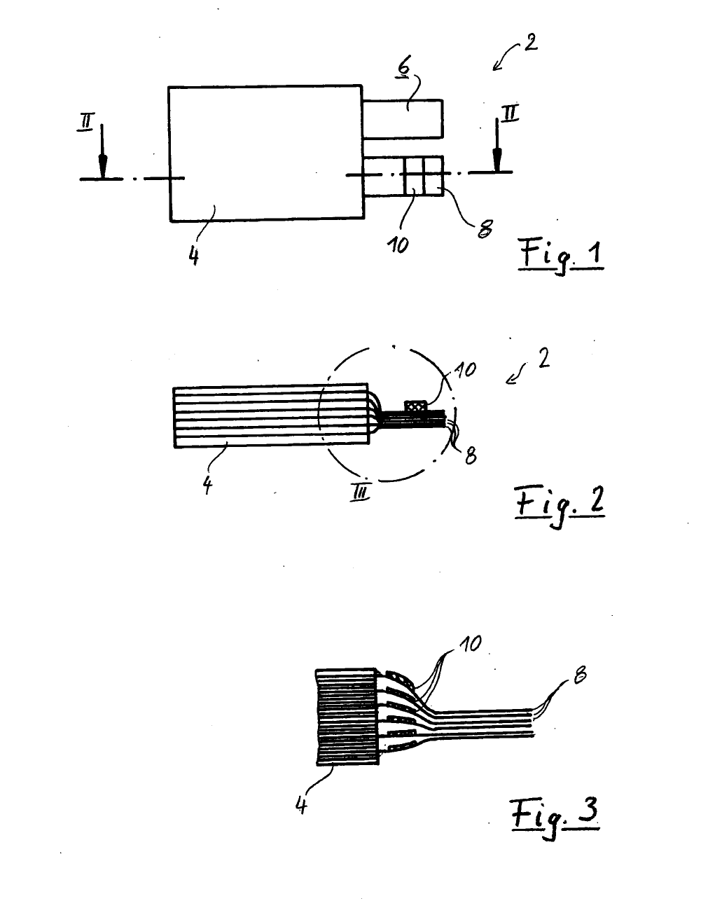

FIG. 2 a longitudinal sectional view of the FIG. 1 cell as viewed along the II-II line in FIG. 1;

FIG. 3 an enlarged view of an end section of a cell according to a further embodiment of the present invention, wherein the area depicted corresponds to detail III from FIG. 2;

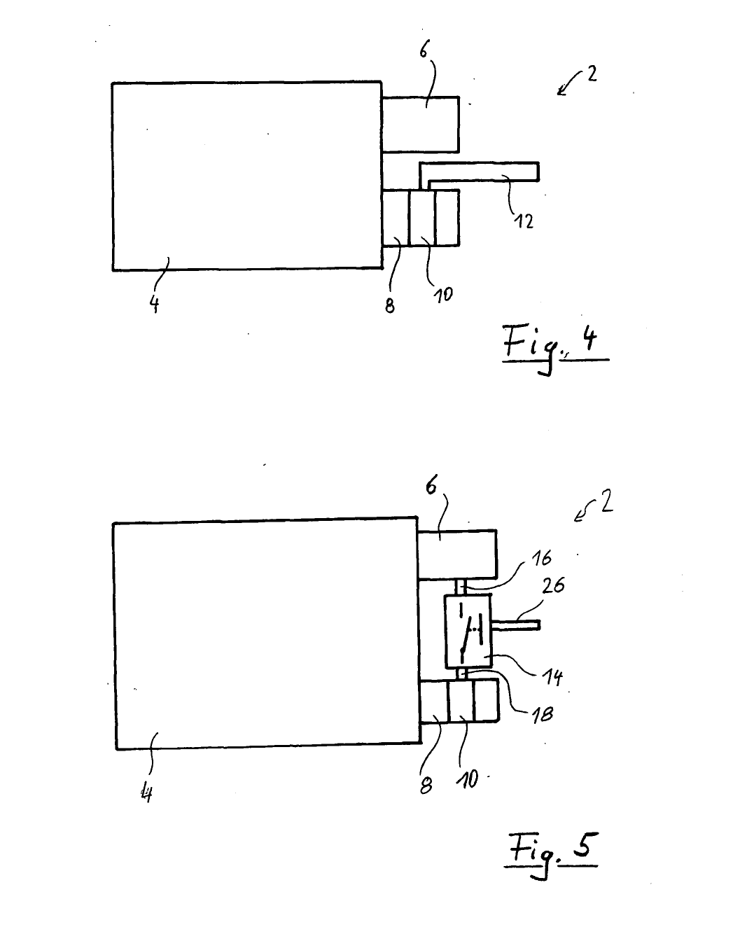

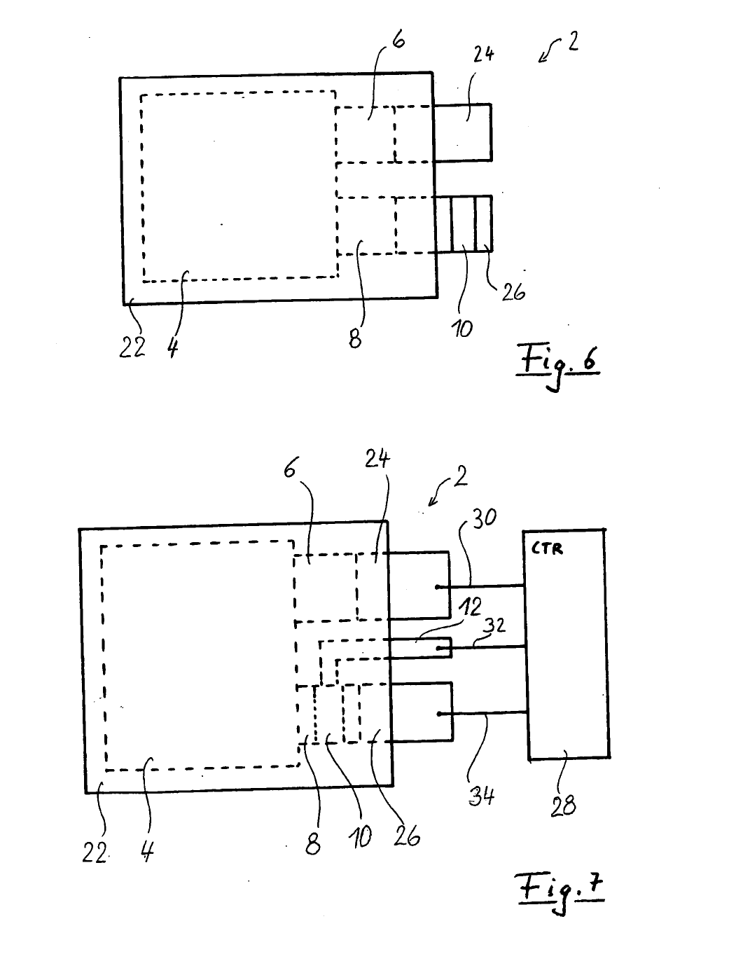

FIG. 4 a plan view commensurate with FIG. 1 of a galvanic cell according to a further embodiment of the present invention;

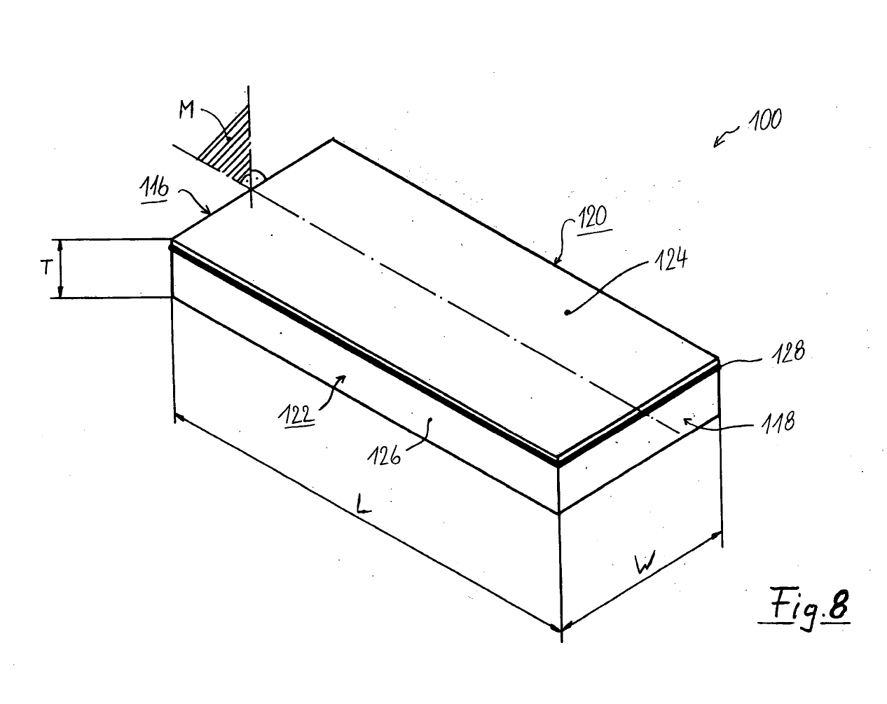

FIG. 5 a plan view commensurate with FIG. 1 of a galvanic cell according to a further embodiment of the present invention;

FIG. 6 a plan view of a galvanic cell according to a further embodiment of the present invention;

FIG. 7 a plan view of a galvanic cell comprising a control device in accordance with a further embodiment of the present invention;

FIG. 8 a spatial representation of an outer construction of a galvanic cell in accordance with a further embodiment of the present invention;

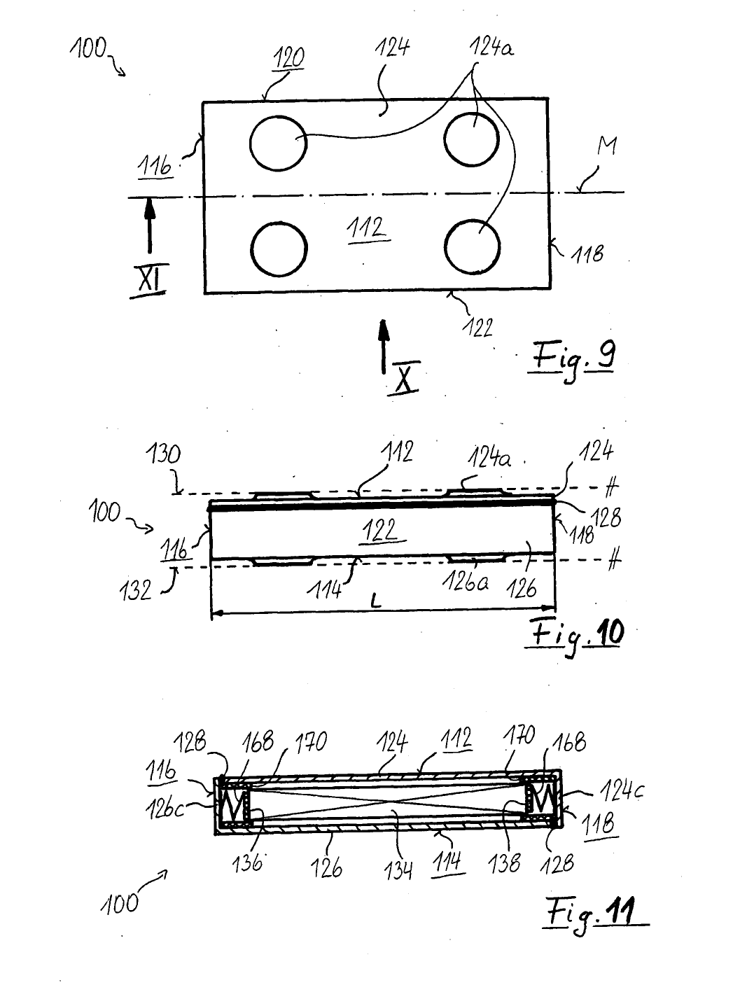

FIG. 9 a plan view of an upper side of the FIG. 8 cell in one embodiment variation;

FIG. 10 a side view of a flank of the FIG. 8 cell in the viewing direction of the “X” arrow in FIG. 9;

FIG. 11 a longitudinal sectional view of the FIG. 8 galvanic cell as viewed along the XI-XI line in FIG. 9;

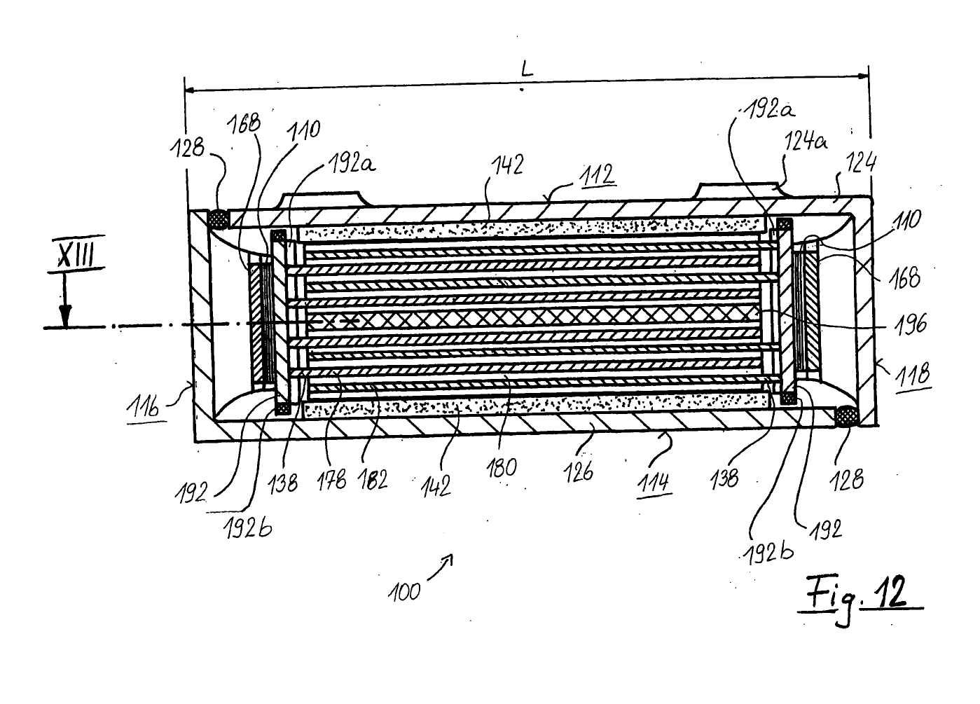

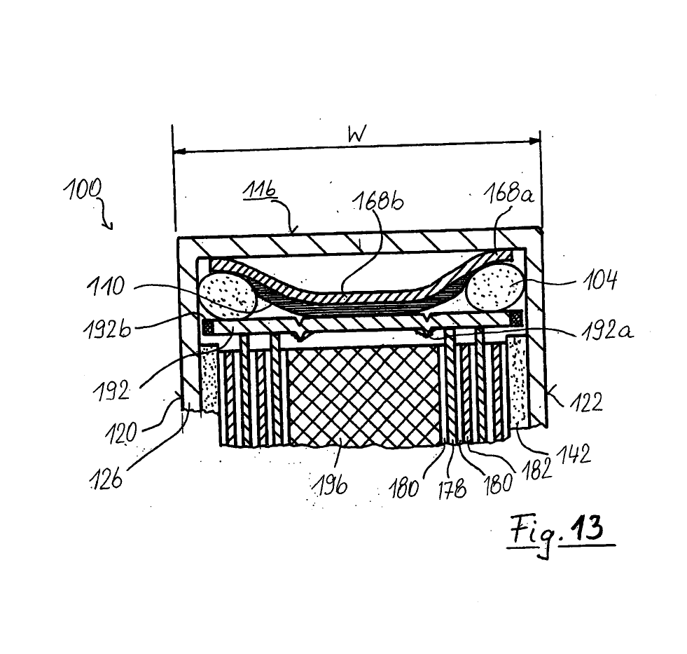

FIG. 12 a longitudinal sectional view of a galvanic cell according to a further embodiment of the present invention;

FIG. 13 an enlarged horizontal sectional view of a frontal region of the FIG. 12 cell along a plane symbolized by the FIG. 12 dashed/dotted line in the viewing direction of the “XIII” arrow;

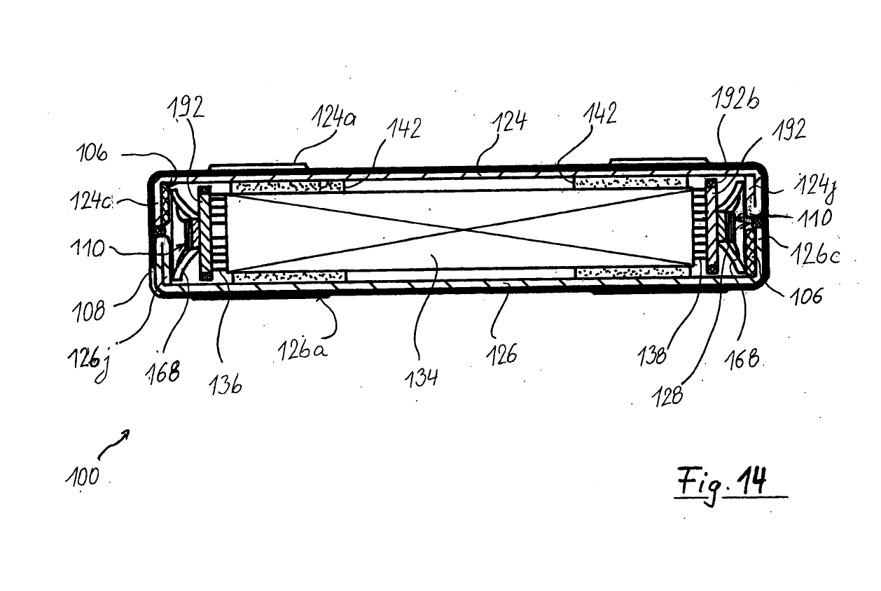

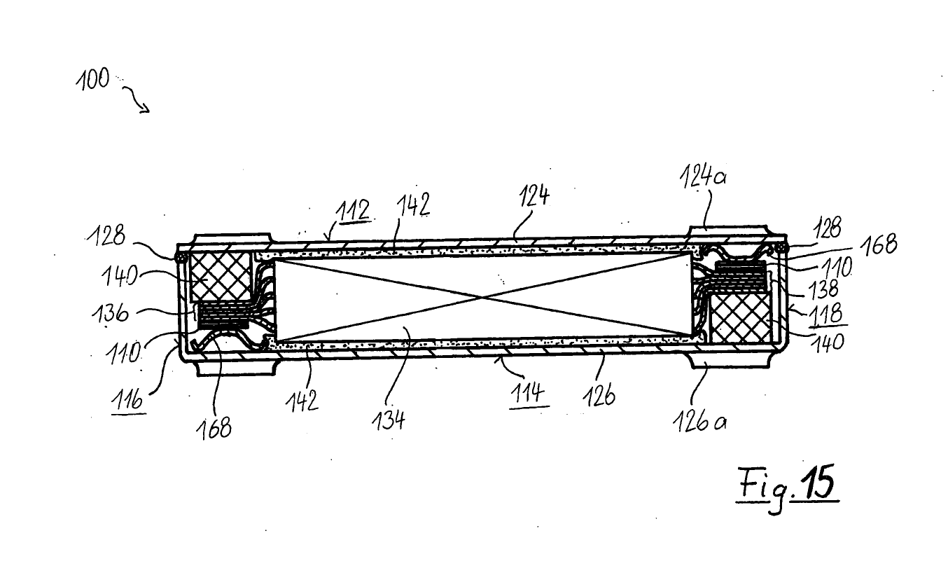

FIG. 14 a longitudinal sectional view of a galvanic cell according to a further embodiment of the present invention;

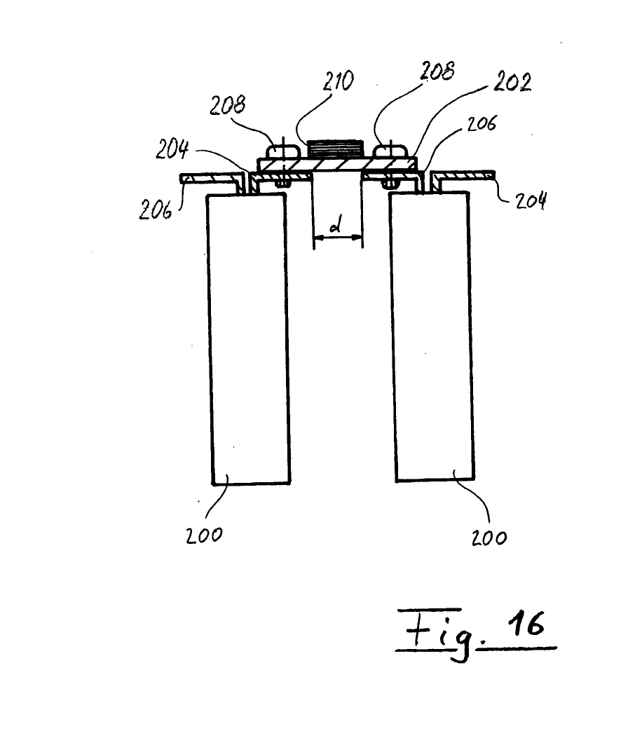

FIG. 15 a longitudinal sectional view of a galvanic cell according to a further embodiment of the present invention;

FIG. 16 a partly sectional side view of an arrangement of two cells having a cell connector in accordance with a further embodiment of the present invention;

FIG. 17 a partly sectional side view of an arrangement of two cells having a cell connector in accordance with a further embodiment of the present invention; and

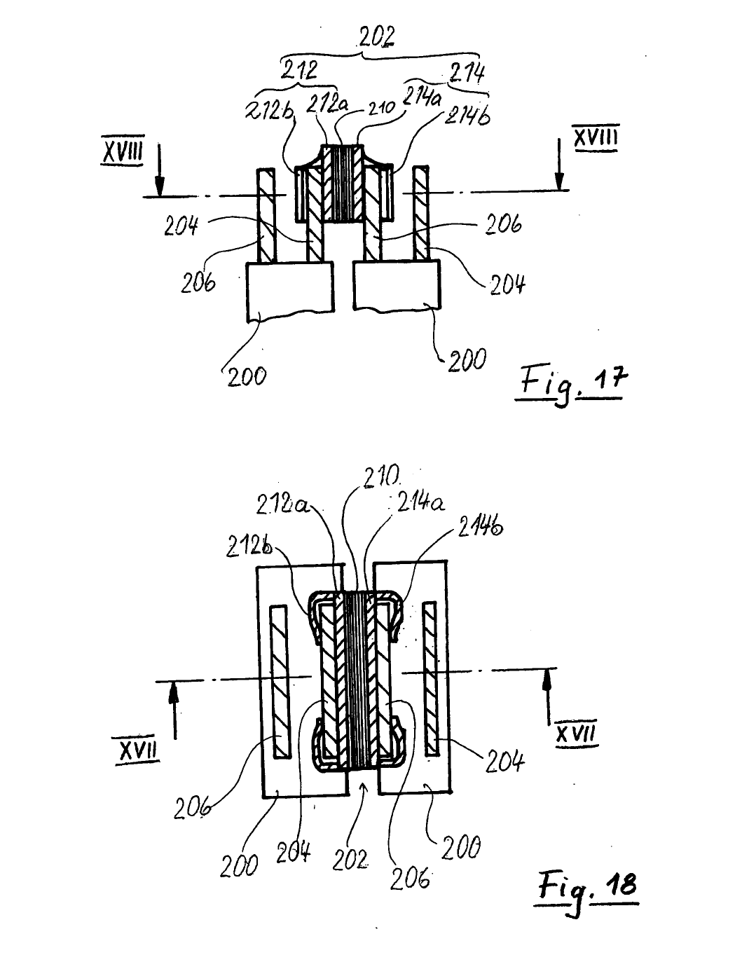

FIG. 18 a sectional plan view of the FIG. 17 arrangement along the XVIII-XVIII line.

It is understood that the depictions in the figures are schematic and are limited to rendering the features helpful to appreciating the invention. It is also pointed out that the dimensions and relative proportions shown in the figures are solely for the purpose of providing representational clarity and are in no way to be understood as limiting unless something to the contrary is referenced in the description. Material thicknesses are in particular often greatly exaggerated in the figures.

The following will make reference to FIG. 1 in describing an embodiment of the present invention.

In accordance with the representation provided in FIG. 1, a galvanic cell 2 comprises an active part 4, the internal structure of which is not depicted in any greater detail. Without limiting the generality, the active part 4 is a bundle-like stacked or coiled assembly of preferably coated foils having electrochemical properties. The foils and/or layers thereby form alternating anode regions, separator regions and cathode regions which serve in the absorbing, converting, storing and discharging of electrical charge energy in the sense of a galvanic cell, as well current collecting areas (so-called collector regions) respectively connected to the anode/cathode regions and serving to discharge or feed electrical charge to or from the anode/cathode regions. There are many known variations of configuring such foil assemblies to form the active part of a galvanic cell.

The current collecting areas, also known simply as collectors, are led out of the actual foil packet as so-called conductor tabs 6, 8 and are, after being allotted to cathode or anode regions, separated, consolidated and joined as need be (pressed, bonded, soldered, riveted or the like). A conceivable enclosure for the cell is not depicted in the figure in any greater detail. An enclosure can be a casing foil, a frame structure, a box structure or the like and form a structure which is gas-tight, liquid-tight and electromagnetically shielding as well as being relatively resistant, mechanically speaking. So-called current conductors (not explicitly depicted) are connected to the conductor tabs 6, 8 within the enclosure and led through the enclosure to the outside, for instance through a welded seam of the enclosure, in order to form the cell's pole contacts. Alternatively, current conductors can be connected directly to the collector areas within the cell or conductor tabs can be led through the enclosure and themselves serve as current conductors.

An exothermic soldering foil 10 is deposited on one of the conductor tabs 6, 8 (in the present case, on conductor tab 8), preferably bonded. The exothermic soldering foil 10 is formed from nanometer reactive multilayers. It serves as a controlled energy storage which can be ignited or self-ignite in response to one or more influences such as temperature, current, voltage, laser pulse or other such influences and then locally and briefly release high thermal energy. Such soldering foils 10 are conventionally used to, for example, provide the thermal energy needed to solder two structural elements when igniting. For its use in the context of the present application, the soldering foil 10 is designed such that it ignites upon a defined overloading of the foil packet 4 (ignition pulse) and releases thermal energy which fuses the conductor tabs 8. This interrupts the current flow to the cell. An ignition pulse can also be selectively introduced from the outside, for instance by a current or voltage pulse. This thus allows tripping just one cell of the assemblage, for example. The soldering foil 10 thereby serves as a multilayer active safety device.

FIG. 2 shows the cell 2 from FIG. 1 in a longitudinal sectional view. The sectional plane symbolized by the dashed/dotted line and associated arrows II-II in FIG. 1 thereby runs through the conductor tab 8.

As FIG. 2 shows, the exothermic soldering foil 10 is disposed on the uppermost soldering lug 8 in an area in which a plurality of conductor tabs 8 are consolidated in the direction of thickness. The soldering foil 10 is a reactive multilayer structure within the meaning of the invention. In terms of its energy output, it is designed such that all soldering lugs 8 are fused upon a reaction.

In one modification of the present embodiment, the soldering foil 10 is provided on both conductor tabs 6, 8.

In a further modification, the energy output is calculated such that only some of the soldering lugs 8 are fused upon a reaction, wherein the common material thickness of the remaining soldering lugs 8 is then no longer sufficient to conduct the cell current without being damaged such that the remaining soldering lugs 8 fuse solely for that reason alone.

In a further modification, a nanometer reactive multilayer is directly vapor-deposited on one or both of the conductor tabs 6, 8 or applied to same by other means. The directly applied reactive multilayer of this modification is likewise a reactive multilayer structure in the sense of the invention.

FIG. 3 shows a further embodiment of the present invention. FIG. 3 depicts the area marked in FIG. 2 by dashed/dotted line III as an enlarged detail.

This embodiment is a modification of the previous embodiment. In accordance with the FIG. 3 representation, a plurality of conductor tabs 8 protrude out of the foil stack (only depicted schematically) of active part 4. Each soldering lug 8 bears an exothermic soldering foil 10 in an area prior to the soldering lugs 8 being consolidated (soldered, bonded, pressed, riveted or the like) in the direction of thickness. In terms of its energy output, it is designed such that the respective soldering lug 8 fuses upon reaction without affecting the other soldering lugs 8 or igniting other soldering foils 10. The arrangement of the soldering foils 10 in the present embodiment is likewise a reactive multilayer structure within the meaning of the invention.

In this present embodiment, it is also particularly simple to trigger segments within a larger cell (e.g. large cell) in the sense of an internal active safety device by selectively igniting individual soldering foils 10. Coiled parts of the anodes or in-sheet batteries can likewise for instance be isolated from sheet segments or entire sheets when the multi-function battery safety device is integrated for instance in the inner contacting segment before or between the contacting sheet.

Instead of individual soldering foils, the modification of directly depositing reactive multilayers on soldering foils 10, for instance when the collector foils associated with the conductor tabs 8 are being manufactured, is also possible in this embodiment.

FIG. 4 shows a further embodiment of the present invention in a depiction corresponding to the plan view of FIG. 1.

This embodiment is a modification of the first or second embodiment. While in those two embodiments, the ignition pulse for the soldering foil 10 is supplied by the conductor tab 8, the soldering foil 10 in the present embodiment is connected to an input lead 12. The input lead 12 can feed an ignition pulse for the soldering foil 10 by means of a control device (not explicitly shown).

The input lead 12 can be a part of the conductor tab 8 or the soldering foil 10. It can alternatively also be a separate conductive member subsequently connected to the conductor tab 8 or the soldering foil 10.

When each conductor tab bears a soldering foil 10 and is connected to its own input lead 12 as in the embodiment depicted in FIG. 3, the individual soldering foils can be individually triggered (i.e. ignited) by the control device (not explicitly shown) and the associated conductor tabs 8 interrupted.

FIG. 5 shows a further embodiment of the present invention in a depiction corresponding to the plan view of FIG. 1.

This embodiment is a modification of one of the embodiments depicted in FIG. 1, 2 or 4. As is the case in those embodiments, the conductor tab 8 bears a soldering foil 10 which ignites upon a predefined ignition pulse, destroying the conductor tab 8. This present embodiment provides for a combinatorial circuit 14 (here e.g. a blocking transistor circuit) connected to the conductor tabs 6, 8 by means of connecting lines 16, 18. Connecting line 18 thereby leads into the conductor tab 8 at the point at which the soldering foil 10 is disposed. The combinatorial circuit 14 can be connected to a control device (not explicitly shown) by a signal line 20. The conductor tabs 6, 8 are isolated from one another when the combinatorial circuit 14 is in a non-active state. Upon a signal S fed from signal line 20, the combinatorial circuit 14 establishes a conductive connection between the conductor tabs 6, 8. The cell 2 is thereby short-circuited. The short-circuit current is sufficient to ignite the soldering foil 10, thus acts as the ignition pulse for the soldering foil 10.

The connecting lines 16, 18 can each be a respective part of the conductor tabs 6 or 8 or soldering foil 10. They can alternatively also be a separate conductive member subsequently connected to the conductor tab 6 or 8 or the soldering foil 10.

The idea behind this embodiment can also be modified in the sense of the embodiment shown in FIG. 3 by providing a combinatorial circuit 14 for each conductor tab 8. For example, individual conductor tabs 8 can be selectively interrupted by the igniting of individual soldering foils 10. This allows for isolating specific areas of the cell 10 in a controlled, targeted manner.

FIG. 6 shows a galvanic cell 2 as a further embodiment of the present invention in a depiction corresponding to the plan view of FIG. 1. FIG. 6 also shows an enclosure 22 for the cell 2 with dashed lines depicting the parts of the cell 10 within the enclosure 22. The enclosure 22 is a foil structure enclosing the active part 4 inclusive of the conductor tabs 6, 8. The enclosure 22 is preferably evacuated and protects the cell 2 from external influences as well as prevents liquids, vapors or gases from leaking out.

The present embodiment is a modification of the first embodiment. In accordance with the FIG. 6 depiction, current conductors 24, 26 are respectively connected to one of the conductor tabs 6, 8 and extend through the enclosure 22.

In this embodiment, an exothermic soldering foil 10 is disposed on the current conductor 26 external of the cell enclosure 22. The soldering foil 10 is designed such that the thermal energy released upon its being ignited fully fuses the current conductor 26 or at least partially fuses it to the extent that the cell current effects the further full fusing.

In this embodiment, the exothermic soldering occurs external of the cell enclosure 10. The interior of the cell 2 is thus kept free of heat input from the exothermic reaction, at least for the most part.

As a modification, an input lead (not explicitly shown) can also be provided here through which an ignition pulse can be supplied to the soldering foil 10.

In a further modification, a reactive multilayer can be deposited directly on the current conductor 26.

FIG. 7 shows a further embodiment of the present invention in a depiction corresponding to the plan view of FIG. 1.

The present embodiment is a modification of the embodiment depicted in FIG. 4. As in FIG. 6, FIG. 7 also shows an enclosure 22 for cell 2 with dashed lines depicting the parts of the cell 10 within the enclosure 22.

As described above, the conductor tab 8 bears a soldering foil 10 which ignites upon a predefined ignition pulse and destroys the conductor tab 8. A current conductor 24 is connected to conductor tab 6 and extends through the enclosure 22. A further current conductor 26 is connected to conductor tab 8 and extends through the enclosure 22. The soldering foil 10 is also connected to an input lead 12 which likewise extends through the enclosure 22.

The present embodiment provides for a control device 28 which is connected to cell 2. A first connecting line 30 thereby connects the first current conductor 24 to the control device 28, a second connecting line 32 connects the input lead 12 to the control device 28, and a third connecting line 34 connects the second current conductor 26 to the control device 28.

The control device 28 is adapted to emit a ignition pulse for the soldering foil 10 by way of connecting line 32 and input lead 12 upon a predetermined internal event occurring such as, for example, reaching a predefined threshold for the cell current, voltage or temperature or another status variable for cell 2 or upon a predetermined external event occurring such as, for example, a predefined accident, theft or another malfunction indicator. Additionally to connecting lines 30, 32, 34, further connecting or signal lines can be provided to connect to sensors within cell 2 or a cell assembly.

The control device 28 can be individually allocated to cell 2. Alternatively, the control device 28 can also be a common control device for a plurality of cells 2. For example, the control device 28 can be part of a battery management system (BMS) for one or more cells or batteries and be connected to e.g. crash sensors or the like.

FIG. 8 schematically depicts the outer construction of a galvanic cell 100 in accordance with a further embodiment of the present invention in a spatial representation.

The galvanic cell 100 is a so-called flat contact cell. It has a flat, more or less rectangular shape. To the end of providing precise reference, an upper side 112, a lower side 114, two faces 116, 118 and two flanks 120, 122 are specified on the cell 100. The upper side 112 and the lower side 114 are arranged at least substantially parallel to one another. The faces 116, 118 and the flanks 120, 122 are likewise each arranged at least substantially parallel to one another. The upper side 112 and the lower side 114 are the sides exhibiting the largest surface area in relation to the other sides and are also referred to as flat sides 112, 114. The dimensions to the flat sides 112, 114 define a length L and a width W of the cell 110, wherein the length L—without limiting the generality—is greater than the width W. The distance of the upper side 112 from the lower side 114 defines a thickness T of the cell 10. The faces 116, 118 and the flanks 120, 122 connect the upper side 112 and the lower side 114 at the peripheral edges, wherein—again without limiting the generality—the faces 116, 118 interconnect the shorter edges of the flat sides 112, 114 of the W (width) dimension and the flanks 120, 122 interconnect the longer edges of the flat sides 112, 114 of the L (length) dimension. The faces 116, 118 and the flanks 120, 122 are also referred to as the narrow sides 116, 118, 120, 122 of the flat contact cell 100. A plane parallel to the flanks 120, 122, which intersects the flat sides 112, 114 at half their width W, defines a center plane M of the cell 100.

The cell 100 comprises an electrochemically active part which is not shown in any greater detail in FIG. 8. The implementation of the first embodiment is in principle applicable for the active part of the cell 100 in the present embodiment. In particular, the active part of the cell 100 is formed by a foil packet.

A housing or enclosure for the foil packet, the active part of the cell 100 respectively, is formed by an upper shell 124 and a lower shell 126, as referred to as half-shells 124, 126. In the embodiment depicted, the lower shell 126 is clearly higher than the upper shell 124. Hence, the lower shell 126 can also be called the trough and the upper shell 124 can be called the cover. This design is wholly exemplary and can be modified with regard to the mechanical, electrical, technical and economic requirements. A seal 128 is disposed at a contact area between the upper shell 124 and the lower shell 126. The half-shells 124, 126 are made from a good conductive material, particularly a metal material such as e.g. copper or aluminum or an alloy thereof. The shape of the half-shells 124, 126 is formed by deep-drawing.

The respective conductor tabs of the active part of the cell 100 are connected to one of the half-shells 124, 126. The half-shells 124, 126 thus form flat contact regions and/or poles for the cell, particularly by means of their defined flat sides 112, 114. The seal 128 exhibits an electrically-insulating property and thus also serves in the reliable electrical isolation of the poles (half-shells 124, 126).

A battery can be produced by aligning a plurality of cells 100 together, wherein the flat sides 112, 114 are in direct contact with one another, realizing an interconnecting of the cells 100 (particularly a series connection).

In one modification, regions of the half-shells 124, 126 not serving in the contacting, for example narrow sides 116, 118, 120, 122, can be coated with an insulating material.

FIGS. 9 and 10 show an embodiment variation of the flat contact cell 100 shown in FIG. 8. FIG. 9 is thereby a plan view of the upper side 112 of cell 100 and FIG. 10 shows a side view of flank 116 (in the viewing direction of the “X” arrow in FIG. 9).

According to the depictions provided in FIGS. 9 and 10, four protrusions 124a are formed on the flat side 112 of upper shell 124 and four protrusions are formed on the flat side 114 of lower shell 126. The protrusions 124a, 126a form circular contact regions and together define a respective contact level 130 on the upper side 112, or a contact level 132 on the lower side 114 respectively, of the cell 100. The protrusions 124a, 126a thus form well-defined contact surfaces, which are to a large extent independent of any possible deformation and/or warping of the flat sides 112, 114 during the operation of cell 100.

FIG. 11 depicts the internal structure of the cell 100 of this embodiment in a longitudinal sectional view. The sectional plane hereby follows the center plane M of the cell 100 (see FIG. 8 or 9) as viewed along the “XI” arrow in FIG. 9.

In the cell 100 of the present embodiment, the half-shells 124, 126 respectively form one of the faces 116, 118 of the cell 100. Each flank 120, 122 of the cell 100 is, as FIG. 10 shows, formed as half of a lateral edge to the half-shells 124, 126. (In an alternative embodiment variation, one of the half-shells 124, 126 can exhibit a lateral edge which extends the entire height of the cell 100 while the other of the half-shells 124, 126 exhibits the basic form of an L-shaped bent sheet.)

Conductor tabs 136, 138 of the foil packet 134 extend a relatively short distance out from the faces of the foil packet 134. Tensioned contact springs (pressure spring) 168 made of an elastically resilient and electrically conductive material are positioned on the conductor tabs 136, 138 projecting from the face and establish an electrical connection to the face edges 124c, 126c of the half-shells 124, 126. The contact springs 168 respectively run to connecting members 170 which are made of an electrically-insulating material and isolate the contact springs 168 from such regions of the half-shells 124, 126 The contact springs 168 also support the foil packet 134 in the longitudinal direction and protect it from housing movements.

The half-shells 124, 126 are made from a metallic material having good conductivity (e.g. steel, aluminum, copper, alloys thereof, etc.) and form the poles of the cell 100. FIG. 11 does not depict any optional protrusions (see FIGS. 9 and 10) on the flat sides 112, 114 nor any optional damping between the foil packet 134 and the flat side or flanks respectively of the cell 100 (i.e. half-shells 124, 126).

FIG. 12 shows a specific embodiment of cell 100 in a corresponding longitudinal sectional view and FIG. 13 shows a frontal region of cell 100 in an enlarged horizontal sectional view along a plane symbolized by the FIG. 12 dashed/dotted line in the viewing direction of the “XIII” arrow.

In accordance with the FIG. 12 depiction, a foil packet 134 of the cell 100 is formed by a foil wrap, although it can also be formed as a foil stack or the like in an embodiment alternative. A first collector foil 178 and a second collector foil 182, each coated with electrode layers, are wound onto a flat winding spindle 196. The electrode material (coating material) provided between the collector foils 178, 182 and the separator material (separator foils 180) are not shaded in FIG. 12 to avoid overloading the depiction. The uncoated ends of the collector foils 178, 182 protrude from different faces of the foil packet 134 and form the conductor tabs 136, 138 of the foil packet 134. A damping 142 is provided between the respective flat sides and flanks of the foil package 134 and the inner surfaces of the half-shells 124, 126 of the cell housing.

In the cell 100 of the present embodiment, a first face 116 of the cell 100 is formed by the lower shell 126 and a second face 118 of the cell 100 is formed by the upper shell 124. A respective contact spring 168 made of a conductive material creates an electrical connection by way of force-locking pressure between the frontal inner side of the lower shell 126 and the conductor tabs 136 or between the frontal inner side of the upper shell 126 and the conductor tabs 138 respectively.

It is to be noted that protrusions 124a are only formed in the upper shell 124 on the upper side 112 of the cell 100 in this embodiment; no protrusions are provided on the lower side 114. The protrusions 124a of the cell 100 are therefore in direct contact with the flat side 114 formed by the lower shell 126 of any given adjacent cell in a stacked arrangement of cells.

The structuring of the force-locking is depicted more clearly in FIG. 13, which shows the face 116 of the cell 100 (lower shell 126) with the associated section of the foil packet 134.

In accordance with the FIG. 13 depiction, the pressure spring 168 exhibits a curved form having two free ends 168a which are supported on the half-shell 126 and an arch-shaped center region 168b pointing toward the face of the foil packet 134. The pressure of the contact spring 168 and the electrical connection are conveyed by means of a contact plate 192 arranged between the contact spring 168 and the conductor tabs 136 of the foil packet 134. The center region 168b of the contact spring abuts the contact plate 192 and the free ends 168a abut the half-shell 126, in each case for a distance which is sufficient to ensure reliable transmission of current. The contact plate 192 exhibits notches 192a peaking toward the conductor tabs 136 and which frontally penetrate into same upon pressure in order to improve the transmission of current. An isolator 192b is affixed to the edge of contact plate 192 which electrically insulates the contact plate 192 from the half-shells 124, 126. The configuration is identical in this respect on the other face (conductor tab 138 side).

As also shown in FIG. 12, an exothermic soldering foil 110 is affixed to the side of the center region 168b of the contact spring 168 facing the contact plate 192. The exothermic soldering foil 110 is configured with nanometer reactive multilayers. This serves as a controlled energy storage which can be ignited by external influences such as, for example, temperature, laser pulse or other variables and then locally and briefly releases high thermal energy. The soldering foil 110 is for example designed such that it ignites upon a defined overloading of the foil packet 134 (ignition pulse) and fuses the contact spring 168. This interrupts the current flow to the cell. The soldering foil 110 thus serves as an active multilayer safety device. Insulating packings 104 disposed between the free ends 168a of the contact spring 168 and the contact plate 192 also maintain the distance between the contact plate 192 and the half-shells 124, 126 upon the fusing of the contact spring 168.

In an optional or alternative modification, an exothermic soldering foil can be affixed to a side facing away from the contact plate or on the contact plate 192 itself; such a configuration can be helpful when, for example, although not limited to, the conductivity of the exothermic soldering foil regresses relative to that of the contact plate and/or the contact spring. In a further modification, the nanometer reactive multilayer can be vapor-deposited or applied by a different process. Although the exothermic soldering foil 10 is provided on the contact spring 168 on both faces 116, 118 in the present embodiment, it can also be omitted from one of the faces 116, 118 in a further modification. In a further modification, more than two notches 192a can be provided in order to further improve the contacting.

FIG. 14 shows a galvanic cell 100 according to a further embodiment of the present invention in a longitudinal sectional view corresponding to that of FIG. 12.

In this embodiment, the half-shells 124, 126 are at least of substantially identical design. In particular, the faces 116, 118 (as well as the flanks 120, 122 not visible in the figure; see FIG. 1) are respectively formed as half of the frontal edges 124c, 126c (and the side edges not visible in the figure). The seal 128 accordingly extends at least substantially circumferentially halfway up in the direction of thickness of the cell 100.

Contact springs 168 are utilized in the present embodiment, their form corresponding to that of the previous embodiment. In particular, the contact springs 168 exhibit a curved form with two free ends (168a, see FIG. 13) supported on the enclosure and an arch-shaped center region 168b pointing toward the face of the foil packet 134. The pressure of the contact spring 168 and the electrical connection are conveyed via a contact plate 192 arranged between the contact spring 168 and the conductor tabs 136 of the foil packet 134.

In accordance with the FIG. 14 depiction, the edges 124c, 126c of the half-shells 124, 126 are bent inward at one face 116, 118 in order to form doubled edges (edge doublings) 124j, 126j (i.e. the edge thickness is doubled at this point due to the double sheet layer). An insulating strip 106 is disposed on the inner side of the respective other face, its thickness at least substantially corresponding to a sheet thickness of the half-shells 124, 126 or its frontal edges 124c, 126c respectively. When assembled, the half-shells 124, 126 are put together such that each doubled edge 124j, 126j faces an edge 124c, 126c with an insulating strip 106.

Due to the above-described configuration, half the free edges of the contact spring 168 rest on half of the doubled edge 124j, 126j of the half-shell 124, 126 forming contact and the other half on an insulating strip 106 which electrically insulates the contact spring 168 from the half-shell 124, 126 not to form contact. By so doing, a respective half-shell 126, 124 is connected to the contact spring 168 on each face 116, 118, and thus to the conductor tabs 136, 138 of a foil packet 134 face, and the other half-shell 124, 126 is reliably isolated therefrom. This thus allows the half-shells 124, 126, or the protrusions 124a, 126a provided on their flat sides respectively, to be used as the poles of the cell 100.

In this embodiment variation, the protrusions 124a of the upper shell 124 are configured smaller than the protrusions 126a of the lower shell 126 in order to identify the pole type for the cell 100. As FIG. 14 shows, the entire outer surface of the cell 100, with the exception of the protrusions 124a, 126a, is provided with a coating 108. The coating 108 is made from an elastic, electrically insulating material such as for example rubber or silicone, and effects a further sealing of the cell 100 on the one hand and, on the other, electrically isolates sections of the cell 100 not serving as poles.

An exothermic soldering foil 110 is respectively provided on the side of the center region 168b of the contact spring 168 facing away from the pressure plates in order to realize an active multilayer safety device as described above. While not explicitly shown in FIG. 14, insulating packing (104; see FIG. 13) can also be provided.

FIG. 15 shows a galvanic cell 100 according to a further embodiment of the present invention in a longitudinal sectional view corresponding to that of FIG. 12.

In this embodiment, the upper shell 124 of the cell 100 exhibits an at least substantially plate-shaped form and the lower shell 126 exhibits an at least substantially trough-shaped form. Contact regions (poles) of the cell 100 are defined by protrusions 124a, 126a formed on the flat sides 112, 114 of the cell 100 (half-shells 124, 126). The upper shell 124 rests on the edge of the lower shell 126 and the seal 128 is circumferentially formed therebetween.

The foil stack 134 comprises frontal opposing conductor tabs 136, 138, their respective flat sides lying atop one another. The flat sides of the conductor tabs 136 in the area of face 116 lie atop one another and are isolated from the upper shell 124 by a contact support 140. An exothermic soldering foil 110 comprising the electrically conductive nanometer reactive multilayers is disposed on the lower side of the conductor tabs 136. A contact clip or spring 168 braces against the lower shell 126, pressing against the soldering foil 110 from below. An electrical contact is thus created between the conductor tabs 136 and the lower shell 126.

The flat sides of the conductor tabs 138 in the area of the other face 118 likewise lie atop one another and are isolated from the lower shell 126 by contact support 140. An exothermic soldering foil 110 comprising the electrically conductive nanometer reactive multilayers is disposed on the upper side of the conductor tabs 138. A contact clip or spring 168 braces against the upper shell 124, pressing against the soldering foil 110 from below. An electrical contact is thus created between the conductor tabs 136 and the upper shell 124.

The soldering foil 110 acts as an active multilayer safety device which reacts upon for example, but not limited to, the foil stack being overloaded or an ignition signal being fed, thereby fusing at least either the conductor tabs 136, 138 or the contact springs 168.

In one modification, the soldering foil 110 forms an isolating layer between the contact springs 168 and the conductor tabs 136, 138 upon ignition.

Protrusions 124a, 126a on the upper shell 124 and/or lower shell 126a serve as contact regions (poles) for the cell. Specific reference is hereby made to the descriptions already provided in this respect. In the present embodiment variation, the protrusions 126a of the upper shell 126 are higher than the protrusion 124a of the lower shell 124 in order to reliably identify the pole types for the cell 100.

As a further variant to the structure of the enclosure, the protrusions 124a or 126a can be replaced by depressions to, on the one hand, identify the pole types, and, on the other, prevent cells 100 from displacing relative one another and, ultimately, increase the packing density of cells 100 within a cell stack.

In a further modification, the soldering foil 110 is only provided on one of the conductor tab packets 136, 138.

FIG. 16 shows an arrangement of two galvanic cells 200 and a connector 202 as a further embodiment of the present invention.

In accordance with the FIG. 16 depiction, one pole 204 of a first cell 200 is connected to one pole 206 of a second cell 200 by means of the connector 202. The connector 202 thereby bridges an open section (distance d) between the poles 204, 206 and is made from a material having good conductivity (steel, aluminum, copper, alloys thereof or the like). The connector 202 is affixed to each of the poles 204, 206 by means of one or more connecting elements 208 (screws, rivets, etc.). Alternatively, the connector 202 can also be clipped, clamped, plugged, bonded, soldered, etc. to the poles 204, 206. The connector 202 furthermore comprises a reactive multilayer 210 in the area of the open section.

In response to an ignition pulse, the layers of the reactive multilayer 210 react exothermically and fuse the connector 202 such that the connector 202 is interrupted in the area of open section d. Hence, the cells 200, 200 are effectively isolated from each other. For ignition pulse types and the triggering of same, reference can be made to the previous remarks provided in conjunction with other embodiments, modifications and variations.

In the embodiment depicted, the current conductors 204, 206 are bent and facing one another. The principle of the invention can, however, also be likewise applied to current conductors in a straight projection or current conductors positioned in different manner.

FIG. 17 shows an arrangement of two galvanic cells 200 and a connector 202 as a further embodiment of the present invention, wherein the galvanic cells 200 are only depicted in the area where the current conductor emerges and the areas at issue are intersected at the center of the current conductors. FIG. 18 is a plan view of the FIG. 17 arrangement along the XVIII-XVIII line from the line of sight of the respective arrows.

In accordance with the FIG. 17 depiction, the current conductors 204, 206 of the cells 200 extend straight upward in this embodiment. A connector 202 to connect the current conductors 204, 206 comprises a first connecting part 212, a second connecting part 214, and a reactive nanometer multilayer 210 (hereinafter referred to as multilayer 210).

The connecting part 212 is made from a material having good electrical conductivity and exhibits a plate section 212a and two spring sections 212b bent toward the plate section. A distance between the spring sections 212b and the plate section 212a is calculated so that a current conductor 204, 206 can be clamped therebetween such that the plate section 212a abuts the current conductor 204/206 and the spring sections engage around the current conductor 204/206 and elastically press against the plate section 212a. The connecting principle behind the connecting part 212 thus corresponds to that of a cable shoe. The connecting part 214 is of similar configuration as the above-described connecting part 212 and exhibits a plate section 214a and two spring sections 214b; the above remarks apply hereto accordingly. In the configuration depicted, connecting part 212 is urged onto the current conductor 204 of the one cell 200 while connecting part 214 is urged onto the current conductor 206 of the other cell 200. The multilayer 210 is disposed between the opposite plate sections 212a, 214a.

In this embodiment, the layers of the multilayer 210 are produced from material having good conductivity. When the multilayer 210 is ignited and has reacted, the reaction product of the multilayer 210 forms an isolating material which electrically isolates connecting parts 212, 214. The multilayer 210 is thus a reactive multilayer structure in the sense of the invention.

In a further embodiment not depicted in any greater detail, respective reactive multilayers form one or more strips or a system of same on a collector foil of a galvanic cell. The galvanic cell is thereby divided into segments. The segments function in conventional manner when the reactive multilayers are not activated and together form the galvanic cell. Upon the reactive multilayers being activated, the amount of heat generated is enough to partially melt or fuse the sections of the cell bordering the reactive multilayer, interrupting the electrical interconnection of the layers. The sections can hence be electrically isolated from one another other.

Thus, in the event of an accident, which can be detected for example by crash sensors on a vehicle, a high-capacity battery can be divided into sections of harmless voltage, for instance in each case under 48 V or the like. Compromised or defective sections (segments) of a cell can also be individually and selectively deactivated during operation.

In a further embodiment, a reversible reactive multilayer can be provided in place of or additionally to an irreversible reactive multilayer. A reversible reactive multilayer is thereby to be understood as being able to restore back to an original state at least once after having been actuated. The reversible reactive multilayer can be disposed at any suitable location as specified above for the purpose of providing an active safety device for galvanic cells.

The reactive multilayers employed in the context of the present application are composed of several hundred to a few thousand alternating layers of at least two materials which can exothermically react with one another. The thicknesses of the individual layers are hereby in the range of preferably 10-50 nm, whereby lower or upper deviations therefrom are also possible. Upon activation energy, an atomic interdiffusion of both materials is induced within the nanometer multilayer, wherein a high release of heat quickly follows. Characteristic properties such as the amount of heat released, the speed of propagation and the maximum temperature to be reached can be selectively influenced by varying the material composition, period thickness and total layer thickness. Thus, a precisely controllable and customized energy/heat source which is in particular also applicable for realizing a protective device for galvanic cells is also provided for industrial application.

To realize the reactive multilayers employed here, other materials and material combinations can be utilized apart from those already noted. The following materials are used, or can be implemented respectively, as layers or layer structures of a reactive multilayer in specific embodiment variations:
nanofillers and dipergent nanomaterial in a suitable material matrix
nanocomposites, e.g. composites comprising carbon nanotubes
functional polymer coating systems, e.g. powder coatings, thin-film UV coatings
multilayer or hybrid systems
combination layers, e.g. laminates
microstructured and nanostructured materials and surfaces
effect or functional materials
surface-active materials
self-assembled monolayers (SAMs) and ultra-thin functional layers such as e.g. functional alkylphosphonic acids, grafted polymers or the like
new alloys
semiconductors
functional materials (inorganic, metallic, metal alloys, diamond-like carbon (DLC), potentially amorphous)
piezoelectric materials, e.g. ceramics, crystals or the like
OLEDs (organic light-emitting diodes)
printable coating materials such as e.g. aqueous or UV-curing or novel curing print inks and varnishes
thin layers
multi-functional multilayers, e.g. tribological properties coupled with sensor/actuator systems, easy-to-clean coupled with scratch resistance, etc.
new materials and material combinations, e.g. nanoparticles, nanocomposites, etc.
gradient layers (material combinations or components, properties)
metals which react with one another and/or conductive polymers as well as sensors (e.g.

thermal sensors) and/or in combination with Al and Si02/Ti02 multilayers, Ti, Zr, Sn and Al; Au, Ag
oxoclusters (frequently used metals for oxoclusters: Sn, Ti, Zr, Hf, Ce, Nb, Mo, W, V)
binary and ternary oxide aerogels (for example: Ti02/Si02, Al203/Si02, 3Al2G-3/2Si03, Fe203/Si02, Fe203/Al203, VzOg/MgO, PbO/Al203, PbO/Zr02, BaO/Al203, xLi20/(1-x)B205, PbTi03, NiO/AlzOVMgO, NiO7Si02/MgO, 2Mg072Al203/5Si02)
3D structures
layered two-dimensional materials embedded in an organic matrix, e.g. graphite oxide in expanded form, embedded in a polyurethane matrix as a nanocomposite

Employing the above-cited materials and/or principles enables and/or requires new technologies which start to blur previous boundaries between the producing and processing of metallic, oxidic and polymeric layers, resulting in many diverse electrical, electronic, magnetic, redox-chemical and photonic application possibilities. The reactive multilayer can also be adapted in terms of shrinkage behavior, rigidity, resistance to heat, inflammability, electrical conductivity, gas permeability etc.

As a further modification, a plurality of conductor tabs can be connected together, e.g. by soldering, and led through the enclosure as a current conductor. In this case as well, an active safety device within the meaning of the invention can be provided internal or external of the enclosure.

In one embodiment, the electrical component is characterized by it being a lithium-ion battery or a lithium-ion accumulator or comprising a lithium-ion battery or a lithium-ion accumulator.

A further object of the invention relates to the use of a composite as defined in the present disclosure for isolating an electrical line connection.

The embodiments and modifications and variations thereof noted in the present application can be combined with one another as well as with any given prior art within the meaning of the invention, insofar as doing so would not be patently impossible. It is pointed out that all the embodiments, modifications and variations thereof as well as all the combinations of their individual features can constitute preferred embodiments of the present invention. In particular, all embodiments provide for isolating an internal or external contacting by means of a reversible or irreversible reactive multilayer. In all of the embodiments, reactive multilayer structures can be directly vapor-deposited, precipitated or otherwise deposited or can be disposed as separate foils or similar structures. To the extent that exothermic soldering forms are employed in the embodiments, this is to be understood in a purely exemplary manner and in no way limits utilizing other reactive multilayer structures.

### LIST OF REFERENCE NUMERALS

2 galvanic cell (pouch cell)
4 active part
6 conductor tab
8 conductor tab
10 exothermic soldering foil (reactive multilayer)
12 input lead
14 combinatorial circuit
16 connecting line
18 connecting line
20 signal line
22 enclosure
24 current conductor
26 current conductor
28 control device
30 connecting line
32 connecting line
34 connecting line
100 galvanic cell (flat contact cell)
106 insulating strip
108 coating
110 exothermic soldering foil (reactive multilayer)
112 upper side (flat side)
114 lower side (flat side)
116 face (narrow side)
118 face (narrow side)
120 flank (narrow side)
122 flank (narrow side)
124 upper shell (half-shell)
124a protrusion (contact region)
124b edge
124c frontal edge
124j doubled edge
126 lower shell (half-shell)
126a protrusion (contact region)
126b edge
126c frontal edge
126j doubled edge
128 seal
130 contact level
132 contact level
134 foil packet
136 conductor tab (collector)
138 conductor tab (collector)
140 contact support
142 damping
168 contact spring
168a free end
168b center region
170 connecting member
178 first collector foil
180 separator foil
182 second collector foil
190 winding spindle (winding core)
192 contact plate
192a notch
192b isolator
194 insulating packing
196 winding spindle
200 galvanic cell
202 cell connector
204 current conductor
206 current conductor
208 fixing means
210 reactive multilayer
212 connecting part
212a plate section
212b spring section
214 connecting part
214a plate section
214b spring section
H cell height
L cell length
M center plane
W cell width
d distance

It is expressly emphasized that the above reference numeral list is an integral part of the description.

1. An electrical component comprising:
a device configured to isolate an electrical line connection,
wherein the device comprises a composite of at least two different materials, and
the at least two different materials are reactive with one another to induce isolation of the electrical line connection.

2. (canceled)

3. The component according to claim 1, wherein the composite is disposed on a section of the line connection and at least two different materials and that thermal energy is released upon reaction of the at least two different materials to cause at least some of the cross section of the line connection to fuse.

4. The component according to claim 3, wherein a portion of the line connection cross section fuses, a remaining cross section of the line connection fuses upon a normal operating current flowing through said line connection.

5. The component according to claim 1, wherein the at least two different materials react to form at least one of a metallic alloy, a metallic glass, a silicide, an aluminide; a boride, a carbide, or a precursor to a thermite.

6. The component according to claim 1, wherein the composite is disposed in a section of the line connection and is electrically conductive, and
an electrically non-conductive reaction product is formed upon reaction of the at least two different materials.

7. The component according to claim 6, wherein one of the at least two different materials is graphite or graphene.

8. The component according to claim 1, wherein the at least two materials of the composite are arranged in alternating layers.

9. The component according to claim 8, wherein the layers include a diameter between 1 to 100 nm independent of one another.

10. The component according to claim 8, wherein the composite comprises between 50 and 10,000 layers.

11. The component according to claim 1, wherein
the reaction between the at least two different materials is triggered by at least one of:
exceeding of a predefined threshold for a current flowing through the line connection section;
exceeding of a predefined threshold for applied voltage over the line connection section;
exceeding of a predefined threshold for a temperature prevailing in the composite or the line connection section;
exceeding of a predefined threshold for an electric potential applied to the composite;
a force effect as a result of an impact or collision.

12. The component according to claim 1, wherein the reaction between the at least two different materials is triggered by input of a current, voltage, temperature, light, acoustic, UV or laser signal or pulse to the isolating device.

13. The component according to claim 1, wherein the component is a cell connector to electrically connect galvanic cells and includes a device to contact pole connections of galvanic cells.

14. The component according to claim 1, further comprising:
an electrochemical storage cell, including at least one of a lithium-ion battery or a lithium-ion accumulator.

15. A method comprising:
isolating an electrical line connection with a composite, the composite including at least two different materials,
wherein the at least two different materials are reactive with one another to induce isolation of the electrical line connection.

16. The component according to claim 1, wherein the component is a galvanic cell and the isolating device is associated with a section or a plurality of sections that conduct electrical current to and/or from the galvanic cell.
